(19) United States
(12) Patent Application Publication
(10) Pub. No.: US 2015/0145887 A1
(43) Pub. Date: May 28, 2015

(54) PERSISTENT HEAD-MOUNTED CONTENT DISPLAY

(71) Applicant: QUALCOMM Incorporated, San Diego, CA (US)

(72) Inventors: Babak Forutanpour, Carlsbad, CA (US); Mark Stirling Caskey, San Diego, CA (US); Geoffrey Carlin Wenger, San Diego, CA (US)

(73) Assignee: QUALCOMM Incorporated, San Diego, CA (US)

(21) Appl. No.: 14/089,402

(22) Filed: Nov. 25, 2013

(51) Int. Cl. G06T 19/00; G02B 27/01; G06F 3/01

(52) U.S. Cl. CPC G06T 19/006; G06F 3/011; G02B 27/0172; G02B 2027/0178; G02B 2027/0198
USPC 345/633

(57) ABSTRACT

A method for persistently displaying selected virtual content includes: selecting desired content; selecting, using a head-mounted display, a physical location as a reference location for the desired content to be displayed virtually as a window of desired content, the physical location being in a line of sight of, but separate from the head-mounted display; and displaying at least a portion of the window of desired content using the head-mounted display such that the at least a portion of the window of desired content appears to a user of the head-mounted display to be disposed at the physical location regardless of changes of orientation, location, or orientation and location of the head-mounted display.

### BACKGROUND

Head-mounted displays (HMDs) exist that allow a user to see the real world in front of the user (as the lenses are transparent) and to see graphic overlays (e.g., from projectors embedded in the HMD frame). Augmented reality (AR) glasses are available today that allow a user to interact with the user's surroundings, while still being able to read email, watch a movie, etc. For example, HMDs exist that have a liquid-crystal display (LCD) in a portion of the user's field of view to facilitate the user obtaining information amenable to the small display, e.g., reading a few lines of email or getting stock quotes. These displays are fixed relative to the frame of the HMD and provide information at a constant position in the user's field of view.

### SUMMARY

An example of a method for persistently displaying selected virtual content includes: selecting desired content; selecting, using a head-mounted display, a physical location as a reference location for the desired content to be displayed virtually as a window of desired content, the physical location being in a line of sight of, but separate from the head-mounted display; and displaying at least a portion of the window of desired content using the head-mounted display such that the at least a portion of the window of desired content appears to a user of the head-mounted display to be disposed at the physical location regardless of changes of orientation, location, or orientation and location of the head-mounted display.

Implementations of such a method may include one or more of the following features. Selecting the desired content includes selecting the desired content using a computer display of a computing device and where selecting the physical location includes moving the desired content off the computer display and onto the head-mounted display. The displaying includes displaying the at least a portion of the window of desired content such that the at least a portion of the window of desired content appears to the user of the head-mounted display to be affixed to the selected location covering a virtual window area. The displaying includes displaying a particular portion of the window of desired content only when a corresponding portion of the virtual window area is within a field of view associated with the head-mounted display. The displaying is implemented using either a forward-facing camera or orientation sensors of the head-mounted display based on at least one of an application associated with the window of desired content, a data size of the window of desired content, or an amount of battery power of the head-mounted display remaining. Displaying the at least a portion of the window of desired content includes repeatedly displaying the at least a portion of the window of desired content based on a present field of view of the head-mounted display and based on at least one of: (1) a location of the head-mounted display, (2) the location of the head-mounted display and a present time, or (3) a present time and a calendar of events associated with the head-mounted display. Selecting the desired content includes a selection event using a computer display, of a computing device of a head-mounted display system including the head-mounted display, the computing device being separate from the head-mounted display, and where selecting the physical location includes tracking a user's hand using the head-mounted display. Selecting the physical location includes identifying a physical marker in a field of view of the head-mounted display, a relative location of the physical marker to the physical location, and an orientation of the head-mounted display, where the physical marker and the physical location are concurrently in the field of view of the head-mounted display when the physical location is selected. Selecting the physical location includes identifying a physical marker in a field of view of the head-mounted display, a relative location of the physical marker to the physical location, and an orientation of the head-mounted display, where the physical marker is outside the field of view of the head-mounted display when the physical location is selected. The method further includes prompting a user of the head-mounted display to move the head-mounted display at least until the physical marker is identified. The method further includes one of accessing the desired content directly from the head-mounted display or receiving the desired content from a computing device, of a head-mounted display system including the head-mounted display, that is distinct from the head-mounted display. The displaying includes displaying the window of desired content with a consistent focal depth for the user in response to a failure to locate a sufficient quantity of reference markers to use to pin the window of desired content to the selected location. The method further includes providing access rights to the desired content to another head-mounted display.

An example of a head-mounted display system includes: a head-mounted display including: a display; a camera; and a processor communicatively coupled to the display and the camera and configured to: receive an indication of desired content; select a physical location as a reference location for the desired content to be displayed virtually as a window of desired content, the physical location being in a line of sight of the camera and separate from the head-mounted display; and cause the display to display at least a portion of the window of desired content such that the at least a portion of the window of desired content appears to a user of the head-mounted display to be disposed at the physical location regardless of changes of orientation, location, or orientation and location of the head-mounted display.

Implementations of such a system may include one or more of the following features. The system further includes a primary computing device separate from and communicatively coupled to the head-mounted display, where the indication of the selected desired content is an indication of transfer of the desired content from the primary computing device to the head-mounted display. The head-mounted display is configured to display the at least a portion of the window of desired content such that the at least a portion of the window of desired content appears to the user of the head-mounted display to be affixed to the selected location covering a virtual window area. The head-mounted display is configured to display a particular portion of the window of desired content only when a corresponding portion of the virtual window area is within a field of view of the head-mounted display. The head-mounted display further includes orientation sensors communicatively coupled to the processor and configured to provide information regarding an orientation of the head-mounted display to the processor, and where the processor is configured to cause the display to display the at least a portion of the window of desired content using either the camera or the orientation sensors based on an application associated with the window of desired content, a size of the window of desired content, or an amount of battery power of the head-mounted display remaining. The processor is configured to cause the display to display the at least a portion of the window repeatedly based on a present field of view of the camera and based on at least one of: (1) a location of the head-mounted display, (2) the location of the head-mounted display and a present time, or (3) a present time and a calendar of events associated with the head-mounted display. The processor is configured to select the physical location by tracking a user's hand using the camera. The processor is configured to select the physical location by identifying a physical marker in a field of view of the head-mounted display, a relative location of the physical marker to the physical location, and an orientation of the head-mounted display, where the physical marker and the physical location are concurrently in the field of view of the head-mounted display when the physical location is selected. The processor is configured to select the physical location by identifying a physical marker in a field of view of the head-mounted display, a relative location of the physical marker to the physical location, and an orientation of the head-mounted display, where the physical marker is outside the field of view of the head-mounted display when the physical location is selected. The processor is further configured to prompt a user of the head-mounted display to move the head-mounted display at least until the physical marker is identified. The system further includes a primary computing device separate from and communicatively coupled to the head-mounted display, where the processor is configured to access the desired content directly or to receive the desired content from the primary computing device. The processor is further configured to cause the display to display the window of desired content with a consistent focal depth for the user in response to a failure to locate a sufficient quantity of reference markers to use to pin the window of desired content to the selected location.

An example of a head-mounted display system including a head-mounted display includes: means for receiving an indication of desired content; means for selecting a physical location as a reference location for the desired content to be displayed virtually as a window of desired content, the physical location being in a line of sight of, but separate from, the head-mounted display; and means for displaying at least a portion of the window of desired content such that the at least a portion of the window of desired content appears to a user of a head-mounted display of the head-mounted display system to be disposed at the physical location regardless of changes of orientation, location, or orientation and location of the head-mounted display.

Implementations of such a system may include one or more of the following features. The system further includes means for selecting the desired content using a display of a computing device that is physically separate from the head-mounted display, and means for transferring an indication of the window of desired content from the computing device to the head-mounted display. The means for displaying are for displaying the at least a portion of the window of desired content such that the at least a portion of the window of desired content appears to the user of the head-mounted display to be affixed to the selected location covering a virtual window area. The means for displaying are for displaying a particular portion of the window of desired content only when a corresponding portion of the virtual window area is within a field of view associated with the head-mounted display. The means for displaying are for displaying the at least a portion of the window of desired content using either a forward-facing camera or orientation sensors of the head-mounted display based on an application associated with the window of desired content, a size of the window of desired content, or an amount of battery power of the head-mounted display remaining. The means for displaying are for displaying repeatedly displaying the at least a portion of the window of desired content based on a present field of view of the head-mounted display and based on at least one of: (1) a location of the head-mounted display, (2) the location of the head-mounted display and a present time, or (3) a present time and a calendar of events associated with the head-mounted display. The system further includes means for selecting the desired content with a touch event of a computer display of a computing device that is separate from the head-mounted display, and where the means for selecting the physical location are for tracking a user's hand using the head-mounted display. The means for selecting the physical location are for identifying a physical marker in a field of view of the head-mounted display, a relative location of the physical marker to the physical location, and an orientation of the head-mounted display, where the physical marker and the physical location are concurrently in the field of view of the head-mounted display when the physical location is selected. The means for selecting the physical location includes means for identifying a physical marker in a field of view of the head-mounted display, a relative location of the physical marker to the physical location, and an orientation of the head-mounted display, where the physical marker is outside the field of view of the head-mounted display when the physical location is selected. The system further includes means for prompting a user of the head-mounted display to move the head-mounted display at least until the physical marker is identified. The system further includes at least one of means for accessing the desired content directly from the head-mounted display or means for receiving the desired content from a computing device that is distinct from the head-mounted display. The means for displaying are further for displaying the window of desired content with a consistent focal depth for the user in response to a failure to locate a sufficient quantity of reference markers to use to pin the window of desired content to the selected location.

An example of a processor-readable storage medium includes processor-readable instructions configured to cause a processor to: select desired content; select, using a head-mounted display, a physical location as a reference location for the desired content to be displayed virtually as a window of desired content, the physical location being in a line of sight of, but separate from the head-mounted display; and display at least a portion of the window of desired content using the head-mounted display such that the at least a portion of the window of desired content appears to a user of the head-mounted display to be disposed at the physical location regardless of changes of orientation, location, or orientation and location of the head-mounted display.

Implementations of such a storage medium may include one or more of the following features. The instructions configured to cause the processor to select the desired content are configured to cause the processor to select the desired content using a computer display of a computing device and where the instructions configured to select the physical location are configured to move the desired content off the computer display and onto the head-mounted display. The instructions configured to cause the processor to display are configured to cause the processor to display the at least a portion of the window of desired content such that the at least a portion of the window of desired content appears to the user of the head-mounted display to be affixed to the selected location covering a virtual window area. The instructions configured to cause the processor to display are configured to cause the processor to display a particular portion of the window of desired content only when a corresponding portion of the virtual window area is within a field of view associated with the head-mounted display. The instructions configured to cause the processor to display are configured to cause the processor to use either a forward-facing camera or orientation sensors of the head-mounted display based on at least one of an application associated with the window of desired content, a data size of the window of desired content, or an amount of battery power of the head-mounted display remaining. The instructions configured to cause the processor to display are configured to cause the processor to display repeatedly the at least a portion of the window of desired content based on a present field of view of the head-mounted display and based on at least one of: (1) a location of the head-mounted display, (2) the location of the head-mounted display and a present time, or (3) a present time and a calendar of events associated with the head-mounted display. The instructions configured to cause the processor to select the desired content are configured to cause the processor to select the desired content in response to a selection event of a computer display, and where the instructions configured to cause the processor to select the physical location are configured to cause the processor to select the physical location by tracking a user's hand using the head-mounted display. The instructions configured to cause the processor to select the physical location are configured to cause the processor to select the physical location by identifying a physical marker in a field of view of the head-mounted display, a relative location of the physical marker to the physical location, and an orientation of the head-mounted display, where the physical marker and the physical location are concurrently in the field of view of the head-mounted display when the physical location is selected. The instructions configured to cause the processor to select the physical location are configured to cause the processor to select the physical location by identifying a physical marker in a field of view of the head-mounted display, a relative location of the physical marker to the physical location, and an orientation of the head-mounted display, where the physical marker is outside the field of view of the head-mounted display when the physical location is selected. The storage medium further includes instructions configured to cause the processor to prompt a user of the head-mounted display to move the head-mounted display at least until the physical marker is identified. The storage medium further includes instructions configured to cause the processor to one of access the desired content directly from the head-mounted display or receive the desired content from a computing device, of a head-mounted display system including the head-mounted display, that is distinct from the head-mounted display. The instructions configured to cause the processor to display are configured to cause the processor to display the window of desired content with a consistent focal depth for the user in response to a failure to locate a sufficient quantity of reference markers to use to pin the window of desired content to the selected location.

Items and/or techniques described herein may provide one or more of the following capabilities, as well as other capabilities not mentioned. Productivity of workers may be improved, e.g., by providing selective access to information at a consistent location and in a manner that is quick and easy to access. Information may be provided to a user in a recurring manner, e.g., based on location, direction of observation, time of day, day of week, time of day and day of week relative to scheduled activity of the user, etc. Surface space, e.g., wall space, in a user's environment is available for use as configurable, persistent virtual displays. A user's environment may be personalized, e.g., with wall paper, posters, personal photos, virtual windows or scenes (e.g., mountains, a beach, flowers, etc.) where no window physically exists. A single environment may concurrently be personalized differently for different users.

### BRIEF DESCRIPTION OF THE DRAWINGS

FIG. 1 is a simplified diagram of a head-mounted display system including a head-mounted display worn by a user.

FIGS. 2A-2B are simplified diagrams of a virtual window displayed by the head-mounted display shown in FIG. 1 at different locations and orientations of the head-mounted display.

FIG. 3 is a block diagram of components of the head-mounted display shown in FIG. 1.

FIG. 4 is a block diagram of components of a primary computing device shown in FIG. 1.

FIG. 5 is a functional block diagram of components of the head-mounted display shown in FIG. 1.

FIGS. 6-7 are block flow diagrams of processes of persistently displaying selected virtual content.

FIG. 8 is a simplified diagram of a user shown in FIG. 1 selecting a location for virtual display of a window of desired content.

FIG. 9 is a diagram of a sample view through a display of the head-mounted display shown in FIG. 1.

### DETAILED DESCRIPTION

Techniques are provided for virtually displaying content at a selectable, fixed, or substantially fixed, physical location. For example, an HMD is provided that allows the user virtually to affix (“pin”) desired content to a physical location. Once pinned, the content is persistent at the pinned location, being visible to the user (i.e., displayed by the HMD) when the window is in the field of view of the HMD, and otherwise not being provided to the user through the HMD. The desired content is displayed as a window, and may contain static content (e.g., a picture) and/or dynamic content (e.g., a news feed, stock ticker, weather radar, etc.). The window may not include a region surrounding information (i.e., a frame may not be provided around the content such as text information, such that perhaps only the content, such as the text, is displayed), in which case the window is the content itself. Further a shape of the window may be independent of the content (e.g., a rectangle regardless of content) or may be dependent on the content (e.g., a shape that is similar to, but larger than, a perimeter of the content).

The new HMD may have many uses. For example, a virtual calendar, a family portrait, a stock ticker, etc. may be placed on a wall. Further, multiple virtual windows may be placed on one or more walls or other surfaces concurrently. Multiple windows may be pinned to a single location and may be displayed in a variety of manners, e.g., layered, offset, transparent, etc. Further still, parameters in addition to location may be associated with display of a selected window, such parameters including time of day and/or day of week, whether an associated window is currently displayed, location and/or orientation of the HMD, etc. A user in a work environment may increase productivity by displaying windows of content that may be accessed at any time by pointing the HMD in the direction of the selected location for the window.

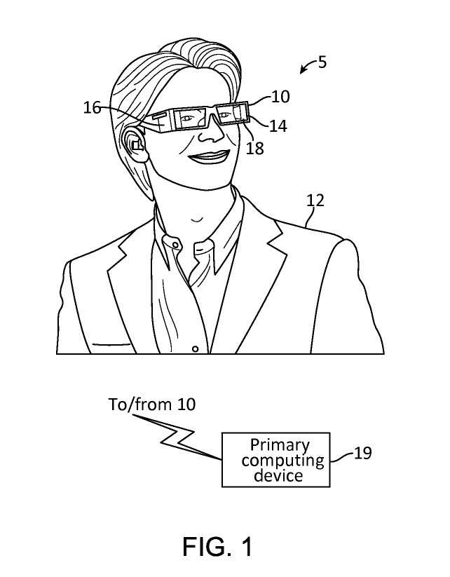

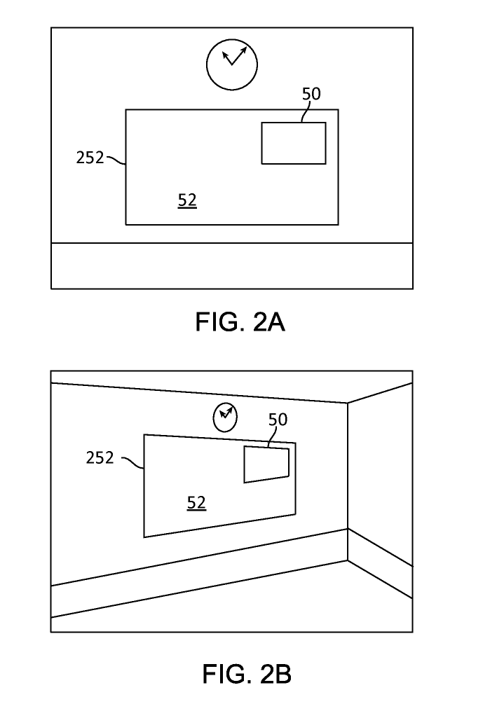

Referring to FIGS. 1, 2A, and 2B, a head-mounted display (HMD) system 5 includes an HMD 10 that can be worn by a user 12, and a primary computing device 19, although head-mounted display systems may be implemented without the primary computing device 19 “Primary,” as used for the primary computing device 19, does not mean that the device 19 is the primary location for computing in the system 10, but rather that the device 19 is typically the device used to select a window of desired content for display on the HMD 10 and thus typically the first device in the system 5 to perform an operation with respect to the window. The HMD 10 is configured to be worn by the user 12, e.g., similar to a pair of glasses, with a frame 14 having arms 16 extending from lens holders 18. The HMD 10 is configured to allow a user to pin (virtually affix) a virtual window 50 to a physical (i.e., not virtual) surface 52 of a whiteboard 252 as shown in FIGS. 2A and 2B. The virtual window 50 will appear to lie flat against the surface 52, and the perspective of the window 50 will change with movement of the user such that the perspective of the window 50 corresponds to the perspective of the surface 52. Thus, with movement of the user's head between a first position and orientation corresponding to FIG. 2A and a second position and orientation corresponding to FIG. 2B, the window 50 will continue to appear to lie flat against, or on, the wall 52.

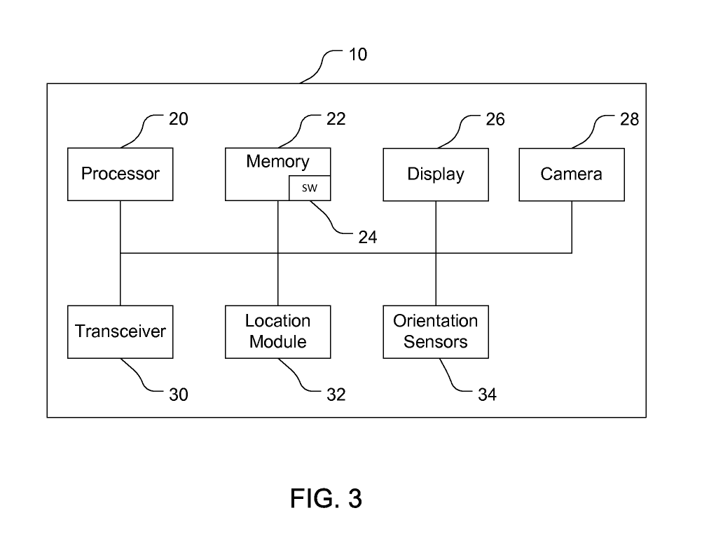

Referring to FIG. 3, the HMD 10 comprises a computer system including a processor 20, memory 22 including software 24, a display 26, a camera 28, a transceiver 30, a location module 32, orientation sensors 34, and a wireless communication module 36. The transceiver 30 includes one or more antennas for use in communicating, and is configured to communicate, e.g., bi-directionally, with other devices including the primary computing device 19 (FIG. 1). The location module 32 is configured to determine a location of the HMD 20 and provide this information to the processor 20 and/or the transceiver 30 for conveyance to another device, such as the primary computing device 19 (FIG. 1). The location module 32 may be a satellite positioning system module such as Global Positioning System (GPS) module. The processor 20 is preferably an intelligent hardware device, e.g., a central processing unit (CPU) such as those made by ARM®, Intel® Corporation, or AMD®, a microcontroller, an application specific integrated circuit (ASIC), etc. The processor 20 could comprise multiple separate physical entities that can be distributed in the system 5. The memory 22 includes random access memory (RAM) and read-only memory (ROM). The memory 22 is a processor-readable storage medium that stores the software 24 which is processor-readable, processor-executable software code containing instructions that are configured to, when executed, cause the processor 20 to perform various functions described herein (although the description may refer only to the processor 20 performing the functions). Alternatively, the software 24 may not be directly executable by the processor 20 but configured to cause the processor 20, e.g., when compiled and executed, to perform the functions. The display 26 is a transparent display, e.g., a visor or, here, lenses, such that the user 12 can see physical objects beyond the display 26 and also see images provided by (e.g., projected onto) the display 26. Images provided by the display 26 may appear to the user 12 as virtual objects physically located beyond the display 26 relative to the user 12.

The location module 32 includes appropriate apparatus for determining location of the HMD 10. For example, the location module 32 may include appropriate equipment for monitoring GPS signals from satellites and determining position of the HMD 10 using one or more antennas of the transceiver 30. The location module 32 may either communicate with the processor 20 to determine location information or can use its own processor for processing the received GPS signals to determine the location of the HMD 10. Further, the location module 32 may communicate with other entities such as a position determination entity and/or a base transceiver station or access point in order to send and/or receive assistance information for use in determining the location of the HMD 10.

The orientation sensors 34 are configured to measure information for use in determining an orientation of the HMD 10. The orientation sensors 34 may include one or more gyroscopes, one or more accelerometers, and/or a compass.

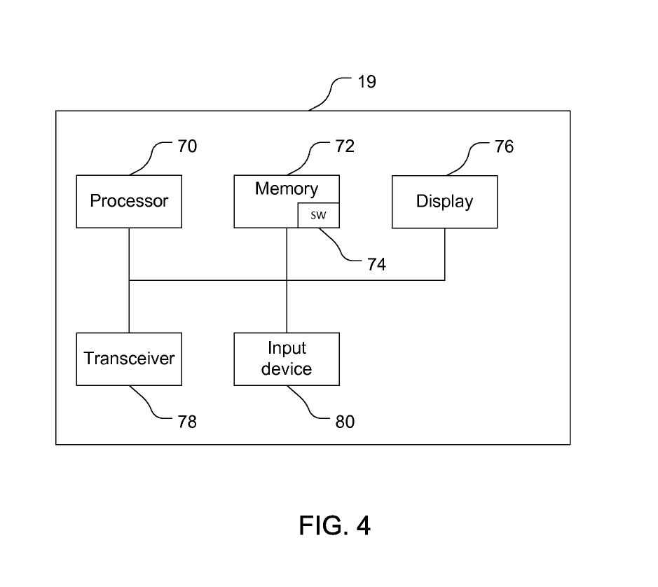

Referring to FIGS. 1 and 4, the primary computing device 19 comprises a computer system including a processor 70, memory 72 including software 74, a display 76, a transceiver 78, and an input device 80. The input device 80 is configured to receive input from a user, e.g., for selection of a window being displayed by the display 76 and to be displayed by the HMD 10. The input device 80 may be one or more of a variety of now-known or later developed input mechanisms such as a mouse. The display 76 may be a touch-sensitive display and thus the input device 80 may include the display 76. The transceiver 78 is configured to communicate bi-directionally with the HMD 10, with other devices including the primary computing device 19. The processor 70 is preferably an intelligent hardware device, e.g., a central processing unit (CPU) such as those made by ARM®, Intel® Corporation, or AMD®, a microcontroller, an application specific integrated circuit (ASIC), etc. The processor 70 could comprise multiple separate physical entities that can be distributed in the system 5. The memory 72 includes random access memory (RAM) and read-only memory (ROM). The memory 72 is a processor-readable storage medium that stores the software 744 which is processor-readable, processor-executable software code containing instructions that are configured to, when executed, cause the processor 70 to perform various functions described herein (although the description may refer only to the processor 70 performing the functions). Alternatively, the software 74 may not be directly executable by the processor 70 but configured to cause the processor 70, e.g., when compiled and executed, to perform the functions.

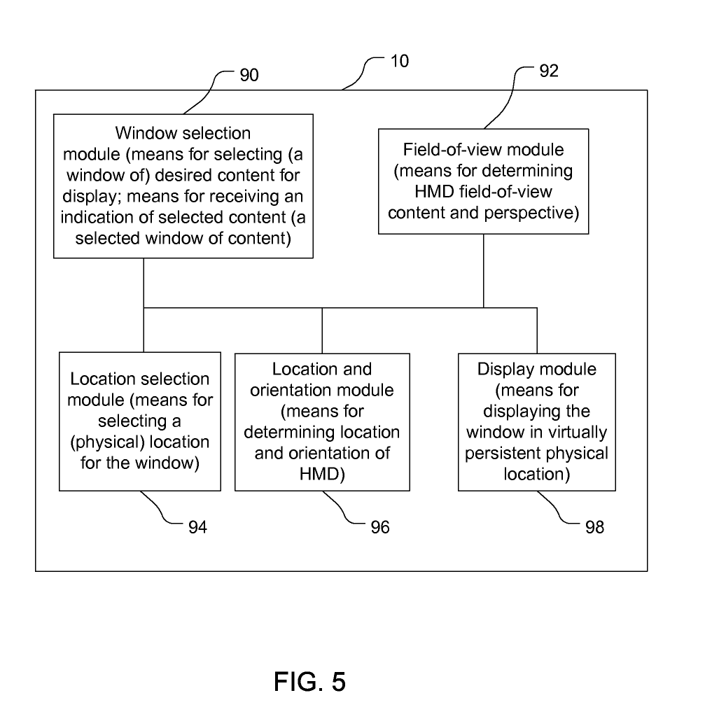

Referring to FIG. 5, with further reference to FIGS. 3-4, the HMD 10 includes a window selection module 40, a field-of-view (FOV) module 42, a location selection module 44, a location and orientation module 46, and a display module 48. The modules 40, 42, 44, 46, 48 are functional modules implemented by the primary computing device 19 and/or the HMD 10 and in particular the processor 20 and/or the processor 70 and the corresponding software 24, 74 in the corresponding memories 22, 72, although the modules 40, 42, 44, 46, 48 could be implemented in hardware, firmware, or software, or combinations of these. Thus, reference to the modules 40, 42, 44, 46, 48 performing or being configured to perform a function is shorthand for the processor 20 and/or the processor 70 performing or being configured to perform the function in accordance with the corresponding software 24, 74 (and/or firmware, and/or hardware of the processor 20, 70). Similarly, reference to the processor 20 and/or the processor 70 performing a function is equivalent to the appropriate module or modules performing the function.

The window selection module 90 comprises means for selecting desired content, e.g., a window of desired content, for display and/or means for receiving an indication of the selected content, e.g., window. The means for selecting the window may reside in the primary computing device 19 and/or the HMD 10. The means for selecting the window may be, e.g., the input device 80 of the device 19 such as a mouse, or a touch-sensitive display of the device 19. The means for selecting the window respond to a selection event such as touch event, e.g., a mouse click on a desired window displayed on the primary computing device 19, to select a window of desired content for transfer of the selected window to the HMD 10. The selection may be of a window itself or another indication, e.g., an icon, of content that may be displayed. A touch event is a user input and may take a variety of forms. For example, a touch event may be a user clicking a mouse button while a cursor icon is displayed over the indication of the window and/or the typing of a text command, etc. As another example, a touch event may be a gesture that is recognized (e.g., with the camera 28 capturing user motion, the user 12 moving a device such as a ring that conveys movement information, etc.). As another example, the touch event may be a touch of a touch-sensitive screen. The touch may take a variety of forms such as a press, a pinch or squeeze motion while in contact with the screen, etc. Still other touch event types are possible. The means for receiving an indication of the selected window portion of the window selection module 90 are in the HMD 10. The indication of the selected window may take a variety of forms such as a command from the device 19 to display the window, a cursor of the primary computing device 19 being moved off of the display 76, the window being moved off of the display 76 of the device 19 (e.g., if the window is being dragged and dropped from the display 76 of the primary computing device 19 to the display 26 of the HMD 10, with the display 26 of the HMD 10 being set up to be an extension of the display 76 of the device 19), more than a threshold percent of the area of the window being moved off of the display 76 of the device 19, etc. The module 90 can recognize, e.g., determine, that the HMD 10 has been in a location previously (e.g., an office space of the user 12) and may recall, e.g., from the memory 22, previously used content for that location. Thus, the module 94 may revert to a previously-used setup (e.g., a last-used, a default setup, etc.) for selected content as the user 12 enters a location. Further, one or more content windows may be provided to the HMD 10 by a device at, or associated with, the location (e.g., a Wi-Fi access point at the location).

The window selection module 90 may select different types of content for display. For example, the selected window of content may be for static content (e.g., a historical document), semi-static content (e.g., a company web page, or a news web page), or dynamic content (e.g., a video). For dynamic content, the content may be stopped from changing (e.g., using a single image of a video) while the window is selected until the window location is selected and the window released as discussed below. Further still, a window displayed to the user 12 while placement of the window is in process may not show the selected content at all. The window shown to the user during placement may be a placeholder, e.g., a black rectangular region, a white rectangular region, a black rectangle, a white rectangle, a rectangular region with graphics and/or text displayed (e.g., a message indicating “release at desired physical location” or the like).

The window selection module 90 may allow the user 12 to set access rights to desired content, e.g., to one or more windows of desired content. The user 12 can operate the input device 80 to set access rights, e.g., to place an “open” setting for corresponding content that is accessible to anyone, a “restricted” setting for corresponding content that is accessible to authorized entities, or a “private” setting for corresponding content that is solely for the HMD 10 and the primary computing device 19. The user 12 can provide access information, e.g., set a password, for content the access to which is restricted. The user 12 may place other accessibility requirements on access to restricted content, e.g., time, day, location, user, etc. restrictions (e.g., content X is only accessible to users A and B, and only on the first Monday of the month between 10:00 AM and 11:00 AM (corresponding to a regular meeting time). Other HMDs and/or primary computing devices may access the open or restricted content (assuming proper access information, e.g., a password, is provided for the restricted content). Optionally, only other HMDs and/or primary computing devices in a vicinity of the HMD 10 or the primary computing device 19 may access the open or restricted content. Alternatively, a window could be used by other users after the HMD 10 moves away from the other users, e.g., if the HMD 10 is in a meeting with other users and the HMD 10 leaves the meeting but the other users continue to use the open or restricted content.

The FOV module (means for determining head-mounted display field-of-view content and perspective) 92 is configured to determine an FOV of the HMD 10, content within that FOV, and perspective of surfaces of the content. Here, the FOV module 92 is configured to use an FOV corresponding to the display 26 (i.e., the FOV of the user 12 that is occupied by the breadth of the display 26) as an FOV of the HMD 10. To do this, the FOV of the camera 28 is calibrated to the FOV of the display 26, and/or vice versa, such that selections by the user 12 as discussed below can be correlated to what the user 12 is looking at through the display 26 (e.g., a desired physical location can be determined from the user 12 looking through the display 26 and making a selection). Also or alternatively, the FOV module 92 may be configured to use as an FOV of the camera 28 as an FOV of the HMD 10, and/or may be configured use an expected FOV of the user as the FOV of the HMD 10, and/or another FOV. The FOV module 92 is configured to determine content of the FOV of the HMD 10, here by capturing content within the FOV of the HMD 10 using the camera 28. Further, the FOV module 92 is configured to determine a perspective of surfaces of the content, e.g., by analyzing lines within the content (e.g., junctions between vertical walls, junctions between a vertical and a ceiling and/or a floor, lines expected to be horizontal or vertical (e.g., of a whiteboard, a picture, a desktop, etc.)).

The location selection module (means for selecting a (physical) location for the window) 94 is configured to associate a location with the selected window such that the window may be “pinned” to the location virtually. The location selection module 94 may be configured to respond to one or more of a variety of selection techniques to associate the location with the window. For example, a physical location may be selected as a physical location in the FOV of the HMD 10 obscured by a cursor icon when a mouse button of the primary computing device 19 is released. Alternatively, the selection technique may be releasing (“unpinching”) of the user's fingers as captured by the camera 28, a pointing movement by the user 12 as captured by the camera 28, blinking by the user (e.g., a threshold number of times within a threshold amount of time while a cursor is obscuring the desired location, or a threshold number of times combined with gaze detection such that where the user 12 is looking is chosen as the selected location), etc. For selection techniques using image capture, the location selection module may be configured to track motion in video captured by the camera 28 in response to a touch event selection of a window. The location selection module 94 may be configured to set the selected location as a center point for the selected window, or another reference point (e.g., upper left corner of the window, etc.).

The location selection module 94 is further configured to obtain and associate visual information with the selected location to facilitate persistent display of the window, especially with appropriate perspective. The location selection module 94 is configured to analyze visual information displaced from the selected location to identify reference markers and their positions. The reference markers are preferably items of fixed location (e.g., a corner of a door frame), or at least typically very stable location (e.g., a corner of a desk), and that are distinguishable by image processing algorithms executed by the window selection module 90. For example, the reference markers could be light switches, book shelves, or whiteboard edges. The location selection module 94 can analyze an image captured by the camera 28 at the time of location selection, but also preferably analyzes images showing areas beyond those in the image captured at the time of location selection, e.g., using images captured before or after the image captured at the time of location selection. The module 94 can determine reference markers and their positions in three-dimensional space, e.g., in absolute terms and/or relative to the selected location. For example, the module 94 can use image analysis and/or knowledge of changes in the location and/or the orientation of the HMD 10 to determine the absolute and/or relative locations of the reference markers. Preferably, reference markers are found that are coplanar or nearly coplanar with a surface on which the selected location is disposed and on which the selected window of desired content is to be displayed and enough reference markers are found to provide perspective for the surface on which to display the window virtually. The module 94 may be configured to prompt the user 12 for input regarding reference markers, e.g., to have the user select locations in the FOV of the HMD 10 of potential reference markers such as corners of rooms, corners of door frames, electrical outlet covers, etc. The module 94 may, for example, analyze portions of images starting from the selected location and expanding radially outward until a threshold number of reference markers are found, or until a threshold distance from the selected location is reached, etc. The module 94 is configured to build a database of reference markers and locations, and may associate these reference marker locations with a location of the HMD 10. The module 94 can recognize, e.g., determine, that the HMD 10 has been in a location previously (e.g., an office space of the user 12) and may recall, e.g., from the memory 22, previously used reference markers as well as previously displayed window locations for the location of the user 12. Thus, the module 94 may revert to a previously-used setup (e.g., a last-used, a default setup, etc.) as the user 12 enters a location. Further, one or more window locations may be provided to the HMD 10 by a device at, or associated with, the location (e.g., a Wi-Fi access point at the location).

A variety of techniques may be used to help find reference markers. For example, simultaneous localization and mapping (SLAM) can be used to build a map of an environment of the HMD 10 and/or parallax mapping techniques may be implemented by the module to determine a planar surface that includes the selected location. Multiple images from the camera 28 may be analyzed to find reference markers. Also or alternatively, the camera 28 may include multiple cameras and images from the multiple cameras may be analyzed to find the reference markers.

Reference markers may be identified to the user 12. The processor 20 may cause the display 26 to highlight a portion of the display 26 over an object that is proposed to be used as a reference marker. The user 12 may override (reject) the use of an identified object as a reference marker (e.g., if the object is highly mobile, such as a mobile phone, a pad of paper, a stapler, a water bottle, etc.). Proposed reference markers may be identified to the user 12 in response to an indication by the user that pinning is not working properly (e.g., a troubleshooting mode) and otherwise not identified to the user 12 (i.e., reference marker identification may be triggered in response to a condition such as a request by the user 12 to enter a troubleshooting mode). Locations of the reference markers may be determined (e.g., based on a present location of the HMD 10 and analysis of one or more images captured by the camera 28) and stored.

The module 94 may be configured to prompt the user to find and indicate a reference marker. For example, if no reference marker is, or less than a desired amount of reference markers are, identified by the module 94, then the module 94 may prompt the user to select locations of possible reference markers. The module 94 will respond to a marker location selection by cataloguing the video information at (including near) the selected location for future use in attempting to locate reference markers for use in determining where to display the window.

The location selection module 94 is preferably also configured to select a physical location to pin a window to without the use of the camera 28. The module 94 may receive a location selection and work with the display module 98 (discussed further below) to display the selected window, initially at a fixed focal length from the user 12. The module 94 may also use orientation information from the orientation sensors 34 in order to cause the display means 98 to display the window oriented with respect to gravity, or the module 94 could cause the display means 98 to display the window with a perspective such that the window is perpendicular to a center of the FOV of the HMD 10. The window may be pinned to the initial location until removed/closed, or may be moved. For example, the module 94 may prompt for and receive input from the user, e.g., using up/down arrow keys, a mouse, hand gestures, etc., to adjust the window until the window is disposed at a desired location and with a desired perspective (e.g., to lie along the surface of a wall). The user may move the window closer to or further from the initially focal length from the user, rotate, and/or tilt (i.e., moving the top or the bottom of the window closer to or further from the user and/or a side of the window closer to or further from the user). The display module 98 will change the perspective of the window if the top, bottom, or side is moved (e.g., to make a window that looks like the window 50 in FIG. 2A look like the window 50 in FIG. 2B). The user may indicate to the location selection module 94 when the window placement and perspective adjustment is complete, and the location selection module 94 can coordinate with the location and orientation module 96 (discussed further below) to pin the location and orientation of the window in three-dimensional space.

The location selection module 94 may be configured to pin the window using or not using the camera 28 based on one or more factors. For example, the module 94 may decide to use the camera 28 or not based on an application that provides the content, orientation of the HMD 10, a data size of the window, and/or remaining battery power of the HMD 10 (e.g., if remaining battery power is over a threshold, then use the camera 28 but otherwise do not use the camera 28). Further, the camera 28 may be used to pin a window to a selected location only when locating reference markers.

The location selection module 94 may be configured to select a location to pin the window to based on one or more factors. For example, pinning the window without the use of the camera 28 may be used, e.g., in response to a battery of the HMD 10 being undesirably low, e.g., below a fixed threshold of battery life, below a dynamic threshold of battery life in view of present battery consumption rate, etc. Conversely, pinning using the camera 28 may be used if the battery level is at a desirable level, e.g., above a fixed threshold of battery life, above a dynamic threshold of battery life in view of present battery consumption rate, etc.

Window content and possibly window location may be shared by the HMD 10 with other devices such as other HMDs. The window selection module 90 may share information regarding selected window content (e.g., what content has been selected) with another device via the transceiver 30. The other device may be another HMD, a device (such as a Wi-Fi access point) that may communicate with other HMDs, etc. Thus, the HMD 10 may share content information with other HMDs directly or indirectly, and/or with other, non-HMD, devices. The module 90 may provide the information regarding the selected window content to the other device, and/or may allow selective access to selected window content (e.g., setting access permissions allowing access to some selections of window content and prohibiting access to other selections of window content). Access may be conditioned upon the entity requesting access (e.g., some entities may be allowed access to a particular content selection while other entities are denied access to that particular content selection). Similarly, the location selection module 94 may window location (i.e., selected location for display of content) may share information regarding a selected display location for selected window content. The information regarding display location may also be based on permissions, and the permissions for access to display location may be different than the permissions for access to selected content (e.g., an entity may be granted access to what content has been selected for the HMD 10 but denied access to where that content is displayed by the HMD 10).

The location and orientation module (means for determining location and orientation of the HMD 10) 96 is configured to determine and store location and orientation of the HMD 10. The module 96 can determine the absolute location (e.g., latitude, longitude, and possibly altitude) and/or relative location (e.g., horizontal coordinates on a floor of a building and possibly height relative to the floor, etc.) of the HMD 10. The module 96 can determine the location of the HMD 10 using the location module 32, e.g., a GPS module, and/or indoor navigation techniques, e.g., using WiFi, etc. The module 96 is also preferably configured to determine a relative location based upon motion sensors (e.g., accelerometers, etc.) in the location module 32. For example, the module 96 set a baseline location when the window is initially selected, and then use the motion sensors to determine relative location to the baseline location. The module 96 can determine an orientation of the HMD 10 using information from the orientation sensors 34. The module 96 can store the location and/or orientation of the HMD 10 for future use, e.g., to adjust a perception of a displayed window, to determine an initial perception of a window to be displayed, etc.

The display module (means for virtually displaying a window) 98 is configured to display a selected window of desired content. The module 98 is configured to display the window initially at a location in the display 26 selected by the user 12, e.g., by releasing a mouse button with a cursor at the location in the display. The selected display location may correspond to a physical location if the camera 28 is used. The display module 98 will initially display the window so that the window is upright, i.e., appearing vertically oriented, e.g., such that text is perpendicular to a direction of gravity, and parallel to a surface containing the selected location. The orientation of the window may be changed by the user 12. The display module 98 is configured to display the window persistently such that the window of content appears to be located at the physical location selected by the user 12. For example, the window may be centered at the location selected by the user 12, e.g., pointed to or covered by a cursor when the user 12 makes the selection, etc. The display module 98 is configured to use information from the location and orientation module 96 to adjust a size and perspective of the window based upon movement of the HMD 10 and/or input from the user 12 (e.g., commands to enlarge, shrink, elongate, heighten, widen, compress vertically and/or horizontally, etc., the window). Thus, as the user 12 moves while wearing the HMD 10, the window is displayed based on the location an orientation of the HMD 10 relative to the physical location selected by the user 12 to be associated with the window. Thus, the module 98 is configured to display the window such that the window mimics a physical item, with the size and perspective of the window having the size, shape, and orientation on the display 26 appropriate to the distance and angle from the user 12 to the physical location selected by the user 12, and appropriate to the orientation of the HMD 10 (e.g., relative to gravity and/or relative to an orientation selected by the user 12).

The display module 98 is preferably also configured to display the window based upon information from the location and orientation module 96, the location selection module 94, and preferably also the FOV module 92. The display module 98 uses information from the camera 28 of the FOV module 92 to locate one or more reference markers. Using the one or more reference markers, and possibly the location and orientation of the HMD 10, the display module 92 can determine where in the display 26 to show the window, and with what size and perception (viewing angle). The size and perception for the window may be determined from the reference markers alone given knowledge of locations of those markers. Images from the camera 28 may be captured on an on-going basis and the reference markers determined frequently. Further, the display module 98 may determine the size and perception of the window based upon present orientation of the HMD 10 (and original window orientation, e.g., if not vertical) and location change of the HMD 10 relative to a baseline location when the window was initially chosen to be displayed, with the location change determined from motion sensor information and without using the camera 28. Also or alternatively, the window may be displayed based upon movement relative to the baseline location as determined from motion sensor information from the location and orientation module 96, the camera 28 used intermittently (e.g., turned off between uses that may be periodic or aperiodic) by the FOV module 92 to determine visible reference markers, the relative location of the selected location relative to the HMD 10 updated, and the displayed window location, size, and/or perspective updated appropriately. Also or alternatively, the location and orientation module 96 may be intermittently used to determine the location of the HMD 10, and this updated location used to determine the relative location from the HMD 10 to the selected physical location for the window and to adjust the displayed window location, size, and perception accordingly. The camera 28 and/or the motion sensors may be turned off between uses, or may be used to capture images and/or motion information infrequently, e.g., to conserve power. Further, the camera 28 and/or the motion sensors may capture images and/or determine motion information, but these images and/or this motion information may not be processed, e.g., to conserve power.

The display module 98 may obtain the information to put on the display 26 from a variety of sources. For example, the primary computing device 19 may provide some or all of the content of the window to the display module 98 that processes the content as appropriate and puts the content on the display 26. As another example, the display module 98 may access some or all of the content of the window independently of the primary computing device 19. For example, the display module 98 may access a server containing the content via a network (e.g., the world-wide web) using the transceiver 30. The display module 98 may obtain a link for use in accessing the server from the primary computing device 19, e.g., to display a video as the window of content. Whether the HMD 10 or the primary computing device 19 obtains the content may depend upon one or more of a variety of factors such as whether the HMD 10 can obtain the content for the same battery cost as the primary computing device 19, whether the content is obtainable by the HMD 10, an amount of processing that would be done by the HMD 10 and/or the primary computing device 19 (e.g., whether either or both devices would need to decode the content). For example, if a document is to be edited, then the display information may be passed from the primary computing device 19 to the HMD 10 and editing performed using the device 19, while a static document may have the content itself passed from the device 19 to the HMD 12.

The display module 98 is configured to update the displayed information. The module 98 updates dynamic content of a window while the user 12 is looking at the window. Preferably, the module 98 refrains from updating (does not update) dynamic content of a window while the user is not looking at the window (e.g., no part of the window is in the FOV of the HMD 10, no part of the window containing dynamic content is in the FOV of the HMD 10, etc.).

A pinned and displayed window may be moved by the user 12. For example, the user 12 may manipulate a cursor and/or provide text commands to change a position or orientation (e.g., tilt and/or rotation) of the displayed window. Also or alternatively, the FOV module 92 may recognize hand gestures by the user 12 to select, move, and/or alter orientation of a displayed window. The window may be slid along a surface corresponding to the selected physical location of the window, or even to a different surface, even one that may be in a different plane than the original surface (e.g., moving the window from an initial wall of a room to another wall of the room, e.g., that may be perpendicular to the initial wall, parallel to, but displaced from the initial wall, or at another angle relative to the initial wall).

Multiple pinned windows may be displayed concurrently. Further, pinned windows may overlap partially or completely. If windows overlap, then the windows may be displayed to indicate that a window is being (partially obscured), e.g., having the windows displayed with a perception of depth, by offsetting the windows from each other so that the obscured window is not totally obscured, etc.

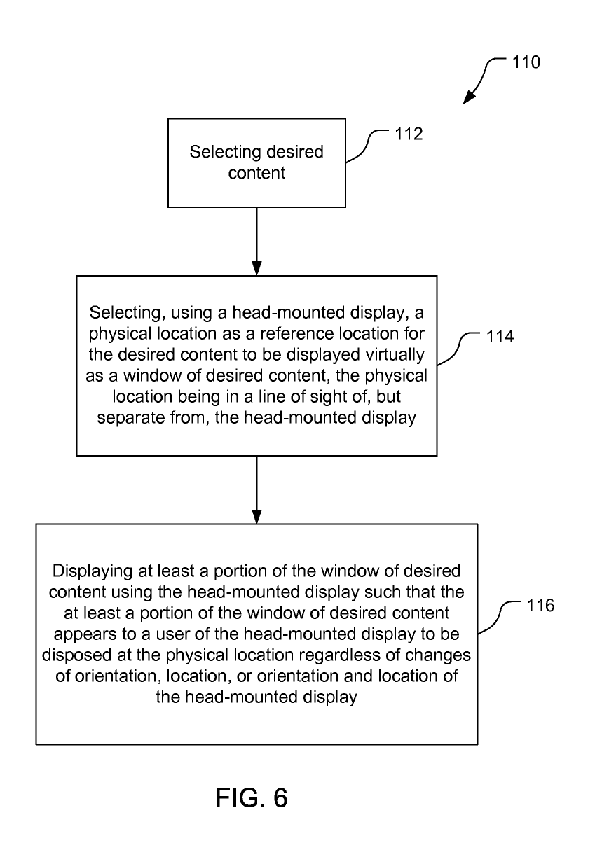

Referring to FIG. 6, with further reference to FIGS. 1-5, a process 110 of persistently displaying selected virtual content includes the stages shown. The process 110 is, however, an example only and not limiting. The process 110 can be altered, e.g., by having stages altered, added, removed, combined, and/or performed concurrently.

At stage 112, the process 110 includes selecting desired content. The desired content may be selected by the user 12, e.g., through a touch event such as by using the input device 80 (such as a mouse) to cause a cursor to on the display 76 to hover over an indication of desired content. The indication may be, e.g., an icon indicative of an application, a rectangular, movable video frame displaying content, etc. Also or alternatively, the desired content may be selected independent of the user 12, at least on a particular occasion. For example, the content may be selected based upon a location of the HMD 10 (e.g., if the user 12 has previously been at this location and selected content, or content is provided by a device at, or associated with, the location), a present time, a calendar entry (e.g., a meeting for the user 12), etc., and/or combinations of these or other criteria. Thus, for example, a similar window of content may be displayed for a recurring meeting (e.g., a budget spreadsheet, sales projections, etc.).

At stage 114, the process 110 includes selecting, using a head-mounted display, a physical location as a reference location for the desired content to be displayed virtually as a window of desired content, the physical location being in a line of sight of, but separate from, the head-mounted display. For example, the HMD 10 can be used in conjunction with the primary computing device 19 to select the location for the window. The selection may be performed in a variety of manners such as those discussed above with respect to the location selection module 94. For example, the user 12 may use the input device 80 (such as a mouse) to drag the window of desired content off of the display 76 of the primary computing device 19 and onto the display 26 of the HMD 10, and “dropping” (e.g., releasing a mouse button) the window when the window is displayed over a physical location to which the user 12 would like to pin (virtually stick or attach) the window of desired content. Also or alternatively, the physical location for virtual display of the desired content may be selected independent of user action, at least on a particular occasion. For example, the location for the content may be selected based upon a location of the HMD 10 (e.g., if the user 12 has previously been at this location and selected content location(s), and/or one or more content locations are provided by a device at, or associated with, the location), a present time, a calendar entry (e.g., a meeting for the user 12), etc., and/or combinations of these or other criteria. Thus, for example, a similar window of content may be displayed at the same location for each of multiple recurring meetings (e.g., a budget spreadsheet shown on a front wall, sales projections shown next to or behind the budget spreadsheet, etc.). Alternatively still, the location of the window of desired content may be provided at a default focal length from the user 12 and with a default orientation, e.g., perpendicular to the user's line of sight, without regard to any physical object within the FOV of the user through the display 26. For example, the window may be provided at the default focal length and orientation in response to the location selection module 94 being unable to determine a sufficient quantity of reference markers to enable persistent display of the window, at least with a desired level of accuracy and/or stillness.

At stage 116, the process 110 includes displaying at least a portion of the window of desired content using the head-mounted display such that the at least a portion of the window of desired content appears to a user of the head-mounted display to be disposed at the physical location regardless of changes of orientation, location, or orientation and location of the head-mounted display. The display module 98 displays the window of desired content on the display 26 (or an appropriate portion of the window) such that the window appears to be affixed to the location selected by the user 12. As the user 12 moves, the window's appearance in the display 26 changes to make the window appear to be stationary on a surface corresponding to the location selected by the user 12. The window may only be partially shown in the display 26, or not shown at all, of the virtually-affixed window is not within a present FOV corresponding to the display 26 based on the user's present location and orientation.

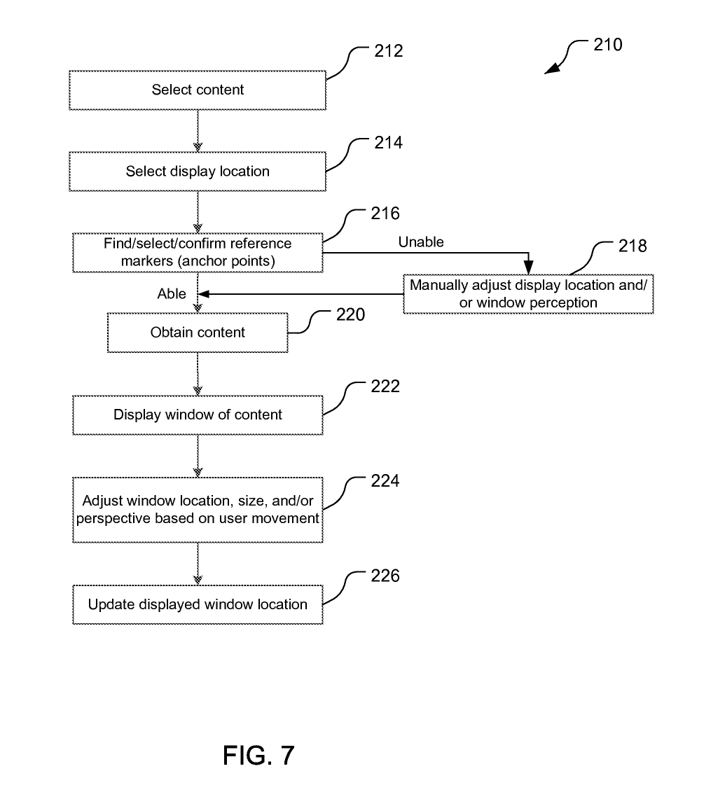

Referring to FIG. 7, with further reference to FIGS. 1-6 and 8-9, a process 210 of persistently displaying selected virtual content includes the stages shown. The process 210 is, however, an example only and not limiting. The process 210 can be altered, e.g., by having stages altered, added, removed, combined, and/or performed concurrently. For example, stage 216 may be eliminated.

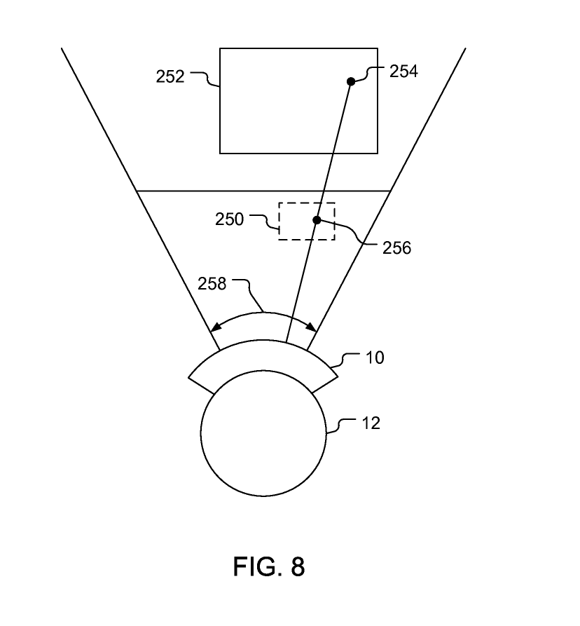

At stages 212 and 214, the process 210 includes selecting content for display and selecting a display location for the content. Stages 212, 214 are similar to stages 112, 114 discussed above with respect to FIG. 6. For example, referring in particular to FIGS. 1 and 8, a window 250 is dragged from the display 76 of the primary computing device 19 and positioned at a desired location, here in an upper right-hand corner of a whiteboard 252.

At stage 216, the process 210 includes finding/selecting/confirming one or more reference markers. The location selection module 94 looks for potential reference markers. For example, referring particularly to FIG. 8, the module 94 may begin at the selected location 254 for the window 250, e.g., which is a point on a ray from the user 12, within an FOV 258 of the HMD 10, passing through a center point 256 of the window 250 that intersects a first surface in view of the user along this ray, here the surface 52 of the whiteboard 252. The module 94 may look radially outward from the point 254 for possible reference markers or anchors to serve as reference points for placing the virtual window 250 and for determining proper perspective (i.e., the angle of the surface on which the window 250 is virtually pinned). The reference markers are preferably stationary, well-defined objects such as a light switch 260, a wall outlet 262, a ceiling corner 264, a floor corner 266, a corner of an object such as a corner 268 of the whiteboard, a clock 270, a door frame or a portion thereof, etc. Preferably, a reference marker is two-dimensional (e.g., not a portion of a line such as a chair rail 272). The module 94 determines information regarding the three-dimensional relationships between the reference markers and the selected location for the window 250 and stores this information (e.g., absolute locations, three-dimensional distances, etc.). While a desired location is being determined, the window 250 may be displayed at a fixed focal length from the user 12 at a position corresponding to the present location indicated by the user 12, e.g, using a mouse, by the user's gaze, etc. Alternatively, the window 250 may be displayed as lying on a surface corresponding to a present physical location corresponding to the window 250, i.e., the location that would be the selected location if the selection occurs presently. In this example, the window 250 would be adjusted to reflect that the whiteboard 250 is extending away from the user 12 from left to right. If sufficient reference markers are found to be able to display the window 250 with desired accuracy, then the process 210 proceeds to stage 220, and if insufficient reference markers are found or selected to display the window 250 with desired accuracy, then the process 210 proceeds to stage 218.

Reference markers may be found outside of an initial FOV of the HMD 10 (i.e., when the location selection is made) to assist with proper placement in three dimensions of the window 250. The module 94 may prompt the user 12 to move the FOV (e.g., walk around, move the user's head, etc.) such that the module 94 can obtain one or more reference markers. The prompting may be persistent until a desired quantity of markers are found (e.g., any marker is found, a sufficient markers found to enable desired display accuracy, etc.), may be periodic prompting until a desired quantity of markers are found, may be an initial prompt and then only a prompt indicating that the user 12 may stop (in response to a desired quantity of reference markers being found), etc.

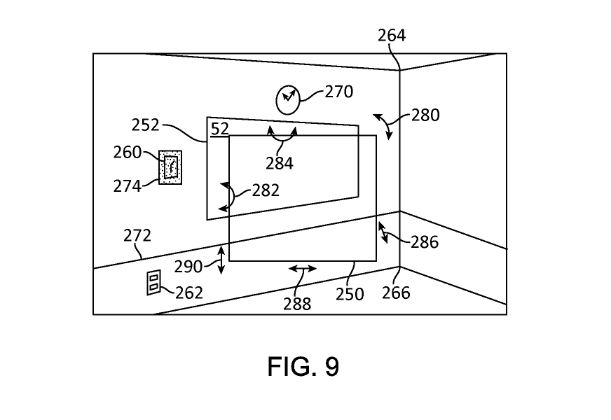

The module 94 preferably indicates would-be reference markers to the user 12, e.g., by highlighting an area of the display 26 over a prospective reference marker. For example, a highlighted area 274 is shown over prospective reference marker 260 in FIG. 9.

The module 94 prompts the user 12 for confirmation as to whether a prospective reference marker should be used as a reference marker (e.g., allowing the user 12 to accept desirable, e.g., typically stationary objects, like the wall outlet 262 while rejecting less desirable, e.g., more frequently moved, objects such as a stapler). If insufficient reference markers are found to be able to display the window 250 with desired accuracy, then the module 94 preferably prompts the user 12 to manually select reference markers. The user 12 selects one or more locations of reference markers, preferably highly discernible, highly stationary objects.

At stage 218, the process 210 includes manually adjusting the display location and/or perception of the window 250. Initially, the window 250, before being released or otherwise having the desired location selected for pinning the window 250, is shown at a fixed focal length from the user 12. The window 250 is manually adjusted by the user 12, e.g., in tilt/rotation/roll indicated by an arrow 280 in FIG. 9, pitch indicated by an arrow 282, yaw indicated by an arrow 284, forward/backward translation indicated by an arrow 286, azimuth (e.g., horizontal) translation indicated by an arrow 288, and elevation (e.g., vertical) translation indicated by an arrow 290. Horizontal and vertical in this example assume that the HMD 10 is facing horizontally (i.e., perpendicular to gravity). The adjustments may be indicated by the user 12, e.g., through the input device 80 of the primary computing device 19. As the adjustments are made, the window 250 is adjusted as appropriate to a proper perception, e.g., to a perception approximating, if not matching, the surface on which the window is pinned virtually (e.g., from looking like the window 250 shown in FIG. 9 to the window 50 shown in FIG. 2B). The user 12 preferably adjusts the three-dimensional position and orientation such that the window 250 virtually overlies a desired surface at a desired location.

At stage 220, the process 210 includes obtaining the selected content. The selected content is provided to the HMD 10 from the computing device 19 and/or obtained by the HMD 10 independently of the computing device 19 as discussed above.

At stage 222, the process 210 includes displaying the window of content. The window, here the window 50, 250 is displayed such that the window 50, 250 appears to be pinned to at the selected location for the window 50, 250. The window is preferably pinned to a flat surface at the selected location, e.g., in this example the surface 52 of the whiteboard 252. Alternatively, the window 50, 250 may be displayed as though not closely overlying a surface if a flat surface of sufficient size for the window 50, 250 is available at the selected location.

At stage 224, the process 210 includes adjusting the window location, size, and perspective (shape) as shown on the display 26 based on user movement. The display module 98 displays the window 50, 250 such that the window 50, 250 persistently appears to be pinned to the surface at the selected location, here to the surface 52. The display module 98 works with the location and orientation module 96 to display the window 50, 250 persistently with substantially constant (e.g, within the abilities/accuracy of the HMD 10 (e.g., of the orientation sensors 24 and the location module 32)) three-dimensional location despite movement of the HMD 10 in location and/or orientation. The window 50, 250 will preferably only be displayed to the extent that the associated area to which the window 50, 250 is pinned is in the FOV of the HMD 10. Thus, some or all of the window 50, 250 may not be shown. Alternatively, the window 50, 250 may be shown in its entirety or not at all, e.g., being removed once a no-display threshold amount of the area corresponding to the window 50, 250 as initially pinned is outside (leaves) of the FOV of the HMD 10, and fully displayed once a display threshold amount of the area corresponding to the window 50, 250 as initially pinned comes within (enters) the FOV of the HMD 10. Reaching the respective threshold triggers the display or termination of display of the window 50, 250.

At stage 226, the process 210 includes updating the displayed window 50, 250 on the display 26. The display module 98 and the location selection module 94 update the displayed window 50, 250 location, size, orientation, and/or perception, as appropriate, by determining the location(s) of one or more reference markers relative to the HMD 10 using the camera 28. The updating may be infrequent, e.g., if battery power of the HMD 10 is low (e.g., present stored energy is below a threshold or presently expected battery life is below a battery life threshold), or frequent, e.g., if the battery power of the HMD 10 is high (e.g., present stored energy is above a threshold or presently expected battery life is above a battery-life threshold).

### Other Considerations

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A wireless communication network does not have all communications transmitted wirelessly, but is configured to have at least some communications transmitted wirelessly.

Further, more than one invention may be disclosed.

1. A method for persistently displaying selected virtual content, the method comprising:
selecting desired content;
selecting, using a head-mounted display, a physical location as a reference location for the desired content to be displayed virtually as a window of desired content, the physical location being in a line of sight of, but separate from the head-mounted display; and
displaying at least a portion of the window of desired content using the head-mounted display such that the at least a portion of the window of desired content appears to a user of the head-mounted display to be disposed at the physical location regardless of changes of orientation, location, or orientation and location of the head-mounted display.

2. The method of claim 1 wherein selecting the desired content comprises selecting the desired content using a computer display of a computing device and wherein selecting the physical location comprises moving the desired content off the computer display and onto the head-mounted display.

3. The method of claim 1 wherein the displaying comprises displaying the at least a portion of the window of desired content such that the at least a portion of the window of desired content appears to the user of the head-mounted display to be affixed to the selected location covering a virtual window area.

4. The method of claim 3 wherein the displaying comprises displaying a particular portion of the window of desired content only when a corresponding portion of the virtual window area is within a field of view associated with the head-mounted display.

5. The method of claim 1 wherein the displaying is implemented using either a forward-facing camera or orientation sensors of the head-mounted display based on at least one of an application associated with the window of desired content, a data size of the window of desired content, or an amount of battery power of the head-mounted display remaining.

6. The method of claim 1 wherein displaying the at least a portion of the window of desired content comprises repeatedly displaying the at least a portion of the window of desired content based on a present field of view of the head-mounted display and based on at least one of: (1) a location of the head-mounted display, (2) the location of the head-mounted display and a present time, or (3) a present time and a calendar of events associated with the head-mounted display.

7. The method of claim 1 wherein selecting the physical location comprises identifying a physical marker in a field of view of the head-mounted display, a relative location of the physical marker to the physical location, and an orientation of the head-mounted display.

8. The method of claim 7 wherein the physical marker is outside the field of view of the head-mounted display when the physical location is selected, the method further comprising prompting a user of the head-mounted display to move the head-mounted display at least until the physical marker is identified.

9. A head-mounted display system comprising:
a head-mounted display comprising:
a display;
a camera; and
a processor communicatively coupled to the display and the camera and configured to:
receive an indication of desired content;
select a physical location as a reference location for the desired content to be displayed virtually as a window of desired content, the physical location being in a line of sight of the camera and separate from the head-mounted display; and
cause the display to display at least a portion of the window of desired content such that the at least a portion of the window of desired content appears to a user of the head-mounted display to be disposed at the physical location regardless of changes of orientation, location, or orientation and location of the head-mounted display.

10. The system of claim 9 further comprising a primary computing device separate from and communicatively coupled to the head-mounted display, wherein the indication of the selected desired content is an indication of transfer of the desired content from the primary computing device to the head-mounted display.

11. The system of claim 9 wherein the head-mounted display is configured to display the at least a portion of the window of desired content such that the at least a portion of the window of desired content appears to the user of the head-mounted display to be affixed to the selected location covering a virtual window area.

12. The system of claim 11 wherein the head-mounted display is configured to display a particular portion of the window of desired content only when a corresponding portion of the virtual window area is within a field of view of the head-mounted display.

13. The system of claim 9 wherein the head-mounted display further comprises orientation sensors communicatively coupled to the processor and configured to provide information regarding an orientation of the head-mounted display to the processor, and wherein the processor is configured to cause the display to display the at least a portion of the window of desired content using either the camera or the orientation sensors based on an application associated with the window of desired content, a size of the window of desired content, or an amount of battery power of the head-mounted display remaining.

14. The system of claim 9 wherein the processor is configured to cause the display to display the at least a portion of the window repeatedly based on a present field of view of the camera and based on at least one of: (1) a location of the head-mounted display, (2) the location of the head-mounted display and a present time, or (3) a present time and a calendar of events associated with the head-mounted display.

15. The system of claim 9 wherein the processor is configured to select the physical location by identifying a physical marker in a field of view of the head-mounted display, a relative location of the physical marker to the physical location, and an orientation of the head-mounted display.

16. A head-mounted display system including a head-mounted display, the system comprising:
means for receiving an indication of desired content;
means for selecting a physical location as a reference location for the desired content to be displayed virtually as a window of desired content, the physical location being in a line of sight of, but separate from, the head-mounted display; and
means for displaying at least a portion of the window of desired content such that the at least a portion of the window of desired content appears to a user of a head-mounted display of the head-mounted display system to be disposed at the physical location regardless of changes of orientation, location, or orientation and location of the head-mounted display.

17. The system of claim 16 further comprising means for selecting the desired content using a display of a computing device that is physically separate from the head-mounted display, and means for transferring an indication of the window of desired content from the computing device to the head-mounted display.

18. The system of claim 16 wherein the means for displaying are for displaying the at least a portion of the window of desired content such that the at least a portion of the window of desired content appears to the user of the head-mounted display to be affixed to the selected location covering a virtual window area.

19. The system of claim 18 wherein the means for displaying are for displaying a particular portion of the window of desired content only when a corresponding portion of the virtual window area is within a field of view associated with the head-mounted display.

20. The system of claim 16 wherein the means for displaying are for displaying the at least a portion of the window of desired content using either a forward-facing camera or orientation sensors of the head-mounted display based on an application associated with the window of desired content, a size of the window of desired content, or an amount of battery power of the head-mounted display remaining.

21. The system of claim 16 wherein the means for displaying are for displaying repeatedly displaying the at least a portion of the window of desired content based on a present field of view of the head-mounted display and based on at least one of: (1) a location of the head-mounted display, (2) the location of the head-mounted display and a present time, or (3) a present time and a calendar of events associated with the head-mounted display.

22. The system of claim 16 wherein the means for selecting the physical location are for identifying a physical marker in a field of view of the head-mounted display, a relative location of the physical marker to the physical location, and an orientation of the head-mounted display.

23. The system of claim 22 further comprising means for prompting a user of the head-mounted display to move the head-mounted display at least until the physical marker is identified in response to the physical marker being outside the field of view of the head-mounted display when the physical location is selected.

24. A processor-readable storage medium comprising processor-readable instructions configured to cause a processor to:
select desired content;
select, using a head-mounted display, a physical location as a reference location for the desired content to be displayed virtually as a window of desired content, the physical location being in a line of sight of, but separate from the head-mounted display; and
display at least a portion of the window of desired content using the head-mounted display such that the at least a portion of the window of desired content appears to a user of the head-mounted display to be disposed at the physical location regardless of changes of orientation, location, or orientation and location of the head-mounted display.

25. The processor-readable storage medium of claim 24 wherein the instructions configured to cause the processor to select the desired content are configured to cause the processor to select the desired content using a computer display of a computing device and wherein the instructions configured to select the physical location are configured to move the desired content off the computer display and onto the head-mounted display.

26. The processor-readable storage medium of claim 24 wherein the instructions configured to cause the processor to display are configured to cause the processor to display the at least a portion of the window of desired content such that the at least a portion of the window of desired content appears to the user of the head-mounted display to be affixed to the selected location covering a virtual window area.

27. The processor-readable storage medium of claim 26 wherein the instructions configured to cause the processor to display are configured to cause the processor to display a particular portion of the window of desired content only when a corresponding portion of the virtual window area is within a field of view associated with the head-mounted display.

28. The processor-readable storage medium of claim 24 wherein the instructions configured to cause the processor to display are configured to cause the processor to use either a forward-facing camera or orientation sensors of the head-mounted display based on at least one of an application associated with the window of desired content, a data size of the window of desired content, or an amount of battery power of the head-mounted display remaining.

29. The processor-readable storage medium of claim 24 wherein the instructions configured to cause the processor to display are configured to cause the processor to display repeatedly the at least a portion of the window of desired content based on a present field of view of the head-mounted display and based on at least one of: (1) a location of the head-mounted display, (2) the location of the head-mounted display and a present time, or (3) a present time and a calendar of events associated with the head-mounted display.

30. The processor-readable storage medium of claim 24 wherein the instructions configured to cause the processor to select the physical location are configured to cause the processor to select the physical location by identifying a physical marker in a field of view of the head-mounted display, a relative location of the physical marker to the physical location, and an orientation of the head-mounted display.
